(19) United States
(12) Patent Application Publication
(10) Pub. No.: US 2026/0269231 A1
(43) Pub. Date: Sep. 10, 2026

(54) ELECTRODE, SECONDARY BATTERY, AND BATTERY PACK

(71) Applicant: KABUSHIKI KAISHA TOSHIBA, Kawasaki-shi (JP)

(72) Inventors: Takatoshi KASUKABE, Yokohama Kanagawa (JP); Naoki NISHIO, Yokohama Kanagawa (JP); Toshitada NAKAZAWA, Yokohama Kanagawa (JP); Takasumi SAITO, Yokohama Kanagawa (JP); Masato YANAGI, Yokohama Kanagawa (JP); Masanori NAGASAKA, Yokohama Kanagawa (JP)

(73) Assignee: KABUSHIKI KAISHA TOSHIBA, Kawasaki-shi (JP)

(21) Appl. No.: 19/662,233

(22) Filed: Apr. 29, 2026

Related U.S. Application Data
(63) Continuation of application No. PCT/JP2024/033752, filed on Sep. 20, 2024.

(51) Int. Cl. H01M 4/505; H01M 4/02; H01M 4/131; H01M 4/525; H01M 10/052

(52) U.S. Cl. CPC H01M 4/505; H01M 4/131; H01M 4/525; H01M 10/052; H01M 2004/021; H01M 2004/027; H01M 2004/028

(57) ABSTRACT

According to one embodiment, an electrode includes an active material including an oxide represented by a general formula LiₓNi_{1-a-b-c}COₐMn_{b}M_{c}O₂ (wherein x, a, b and c satisfy 0.9≤x≤1.25, 0.05≤a≤0.5, 0.03<b≤0.5, and 0≤c≤0.2, and M includes one or more metal elements other than Ni, Co and Mn). The electrode satisfies 0.001<B/(A+B)≤0.09 (1)
wherein A is a pore volume (mL/g) in a pore size diameter range of 0.01 μm or more and 0.3 μm or less in a mercury intrusion pore size diameter distribution of the electrode, and B is a pore volume (mL/g) in a pore size diameter range of more than 0.3 μm and 1 μm or less in the mercury intrusion pore size diameter distribution.

### CROSS-REFERENCE TO RELATED APPLICATIONS

This application is a Continuation Application of PCT Application No. PCT/JP2024/033752, filed Sep. 20, 2024, the entire contents of which are incorporated herein by reference.

### FIELD

Embodiments of the present invention relate to an electrode, secondary battery, and battery pack.

### BACKGROUND

With the recent increase in capacity of lithium ion batteries, improvement in energy density has been required. A nickel cobalt manganese composite oxide, lithium iron phosphate, a lithium manganese oxide and the like are known as positive electrode active materials for lithium ion batteries. As one of methods for further increasing the capacity of a battery in which a nickel cobalt manganese composite oxide is used for a positive electrode, increasing of the proportion of nickel in the nickel cobalt manganese composite oxide is known.

In a battery including a positive electrode containing a nickel cobalt manganese composite oxide as an active material, the amount of gas generation associated with degradation of the active material is large in a case where charge and discharge are performed under conditions involving a wide range of states of charge (SOC). In particular, in a case where a nickel cobalt manganese composite oxide having a high proportion of nickel is used, the amount of gas generation markedly increases. Therefore, both an increased capacity of a battery and prevention of gas generation are needed.

### BRIEF DESCRIPTION OF THE DRAWINGS

FIG. 1 is a plan view schematically showing an example of an electrode.

FIG. 2 shows a cross-section obtained by cutting an exemplar battery according to the embodiment in a thickness direction.

FIG. 3 is an enlarged sectional view of a section E in FIG. 2.

FIG. 4 is a partially cutaway perspective view of another example of the battery according to the embodiment.

FIG. 5 is an exploded perspective view of an exemplar battery pack according to an embodiment.

FIG. 6 is a block diagram showing an electric circuit of the battery pack shown in FIG. 5.

FIG. 7 is a diagram showing an example of mercury intrusion pore size diameter distributions in electrodes of examples and comparative examples.

### DETAILED DESCRIPTION

Objects are to provide an electrode capable of preventing gas generation while increasing the capacity of a battery, and to provide a secondary battery and a battery pack which include the electrode.

According to one embodiment, an electrode includes an active material including an oxide represented by a general formula LiₓNi_{1-a-b-c}COₐMn_{b}M_{c}O₂ (wherein x, a, b and c satisfy 0.9≤x≤1.25, 0.05≤a≤0.5, 0.03≤b≤0.5, and 0≤c≤0.2, and M includes one or more metal elements other than Ni, Co and Mn). The electrode satisfies the following expression (1):

$$0.001 < B / ( A + B ) \leq 0.09 \qquad ( 1 )$$

wherein A is a pore volume (mL/g) in a pore size diameter range of 0.01 μm or more and 0.3 μm or less in a mercury intrusion pore size diameter distribution of the electrode, and B is a pore volume (mL/g) in a pore size diameter range of more than 0.3 μm and 1 μm or less in the mercury intrusion pore size diameter distribution.

According to the embodiment, a secondary battery includes a positive electrode, a negative electrode, and an electrolyte. The positive electrode is the electrode according to the embodiment.

According to the embodiment, a battery pack includes the secondary battery according to the embodiment.

Hereinafter, embodiments will be described with reference to the drawings. The same reference signs are applied to common components throughout the embodiments and overlapping explanations are omitted.

Each drawing is a schematic view for explaining the embodiment and promoting understanding thereof; though there may be differences in shape, size and ratio from those in an actual device, such specifics can be appropriately changed in design taking the following explanations and known technology into consideration.

### First Embodiment

A first embodiment relates to an electrode. The electrode contains an active material containing an oxide represented by a general formula LiₓNi_{1-a-b-c}COₐMn_{b}M_{c}O₂. In the general formula, x, a, b, and c satisfy 0.9≤x≤1.25, 0.05≤a≤0.5, 0.03≤b≤0.5, and 0≤c≤0.2. M includes one or more metal elements other than Ni, Co, and Mn. The electrode satisfies the following expression (1).

$$0.001 < B / ( A + B ) \leq 0.09 \qquad ( 1 )$$

In the expression (1), A is a pore volume (mL/g) in a pore size diameter range of 0.01 μm or more and 0.3 μm or less in a mercury intrusion pore size diameter distribution of the electrode, and B is a pore volume (mL/g) in a pore size diameter range of more than 0.3 μm and 1 μm or less in a mercury intrusion pore size diameter distribution of the electrode. Here, in the mercury intrusion pore size diameter distribution, the horizontal axis represents a pore size diameter (μm), and the vertical axis represents a Log differential intrusion (mL/g). A method for measuring a mercury intrusion pore size diameter distribution will be described later.

The electrode of the embodiment is capable of reducing gas generation even during charge/discharge cycles. The mechanism by which a gas generation preventing effect is obtained is not known, but is presumed to be as described below.

The electrode of the embodiment may be used, for example, in a nonaqueous electrolyte secondary battery such as a lithium secondary battery. An example of the secondary battery includes an electrolyte containing a solvent. In the electrolyte, Li ions (Li⁺) may diffuse with a shell (also referred to as a solvation structure) having a Stokes radius larger than the Stokes radius of the solvent molecule. Pores whose pore size diameter is in a range of more than 0.3 μm and 1 μm or less can promote diffusion of solvated Li ions in the electrode. On the other hand, an electrode having pores whose pore size diameter is in a range of 0.01 μm or more and 0.3 μm or less is likely to have an increased density. Therefore, pores whose pore size diameter is in a range of 0.01 μm or more and 0.3 μm or less can contribute to an increase in capacity of the electrode.

By setting the value of B/(A+B) to more than 0.001, entrance of solvated Li ions into pores and diffusion of Li ions can be promoted. On the other hand, an increase in value of B/(A+B) may interfere with contact between an active material and an electro-conductive agent. If the contact between the active material and the electro-conductive agent is not sufficient, electro-current constriction is likely to occur. By setting the value of B/(A+B) to more than 0.001 and 0.09 or less, entrance of solvated Li ions into pores and diffusion of Li ions can be promoted while the contact between the active material and the electro-conductive agent is secured. As a result, the electrode can evenly and substantially uniformly react in charge and discharge, so that generation during charge/discharge cycles can be prevented. Thus, the charge/discharge cycle life can be improved.

Therefore, by setting the value of B/(A+B) to more than 0.001 and 0.09 or less, an electrode which has a high capacity and generates little gas can be provided. The value of B/(A+B) can be more than 0.001 and 0.025 or less. When the value of B/(A+B) is in this range, the amount of gas generation can be further reduced. Therefore, the charge/discharge cycle life can be improved.

Hereinafter, the electrode will be described in detail.

The electrode has pores whose pore size diameter is in a range of 0.01 μm or more and 1 μm or less. The electrode may have only pores whose pore size diameter is in a range of 0.01 μm or more and 1 μm or less, but may have pores whose size is outside this range. In the electrode, for example, the ratio of the pore volume (mL/g) represented by (A+B) in the expression (1) to the pore volume (mL/g) at a pore size diameter of 0.01 μm or more and 60 μm or less in the mercury intrusion pore size diameter distribution (hereinafter, referred to as a pore volume C) may be 80% or more. In an electrode where the ratio of the pore volume (A+B) to the pore volume C is 80% or more, most of the pores having a pore size diameter of 0.01 μm or more and 60 μm or less are pores whose pore size diameter is in a range of 0.01 μm or more and 1 μm or less, and therefore, a gas generation preventing effect specified by the expression (1) is easily obtained. The pore size diameter of pores of an electrode in which the ratio of the pore volume (A+B) is 100% is in a range of 0.01 μm or more and 1 μm or less. The ratio may be in a range of 80% or more and 100% or less, but the upper limit value of the ratio is desirably 90%. By setting the ratio to 80% or more and 90% or less, the ratio of pores whose pore size diameter is in a range of 0.01 μm or more and 1 μm or less and pores whose pore size diameter exceeds 1 μm can be optimized. As a result, the diffusibility of Li ions can be further improved to enhance the uniformity of charge/discharge reactions in the electrode, so that the amount of gas generation during charge/discharge cycles can be further reduced.

The electrode can have at least one peak in a pore size diameter range of 0.1 μm or more and 0.3 μm or less in the mercury intrusion pore size diameter distribution. At least one peak desirably includes a peak having a maximum height. Here, when a pore volume (mL/g) in a pore size diameter range of 0.003 μm or more and 0.005 μm or less is a minimum pore volume, the peak has a pore volume exceeding the minimum pore volume. The peak having a maximum height is a peak in which the maximum value of the Log differential intrusion in a pore size diameter range of 0.01 μm or more and 1 μm or less is a peak top.

By existence of a peak having a maximum height in a pore size diameter range of 0.1 μm or more and 0.3 μm or less, pores whose pore size diameter is in a range of 0.1 μm or more and 0.3 μm or less are allowed to exist more than pores whose pore size diameter is outside the range. As a result, the gas generation preventing effect of the expression (1) can be further enhanced.

The electrode may include, for example, a current collector and an electrode material layer (active material-containing layer). The electrode may be a positive electrode or a negative electrode.

The current collector may have, for example, a first surface, and a second surface as a back surface of the first surface. The current collector may have, for example, a band shape or a sheet shape.

The current collector is preferably an aluminum foil, or an aluminum alloy foil containing aluminum, and one or more elements selected from Mg, Ti, Zn, Mn, Fe, Cu, and Si.

The active material-containing layer may be formed, for example, on both the first surface and the second surface of the current collector. Alternatively, the active material-containing layer may be formed on one of the first surface and the second surface of the current collector. The current collector may include a portion in which the active material-containing layer is not supported either on the first surface or on the second surface. This portion can serve as, for example, an electrode tab or an electrode lead.

The active material-containing layer may contain an active material. The active material contains an oxide represented by a general formula LiₓNi_{1-a-b-c}COₐMn_{b}M_{c}O₂ (hereinafter, referred to as a first oxide). The first oxide can also be referred to as a lithium/nickel/cobalt/manganese-containing oxide, or a lithium nickel cobalt manganese composite oxide. The lithium/nickel/cobalt/manganese-containing oxide may have a layered structure. In the general formula, x, a, b, and c satisfy 0.9≤x≤1.25, 0.05≤a≤0.5, 0.03≤b≤0.5, and 0 5≤c≤0.2. M includes one or more metal elements other than Ni, Co, and Mn. The reason why x, a, b and c are limited within the above ranges will be described below.

The value of x may change within a range of 0.9 or more and 1.25 or less. When x is 0.9 or more, the active material can maintain a stable crystal structure. When x is 1.25 or less, the discharge capacity can be increased.

By setting the value of (1-a-b-c) to 0.49 or more, a high-capacity active material is obtained, so that the energy density of the battery can be increased. When the value of (1-a-b-c) is 0.9 or less, deterioration of structural stability and heat stability of the active material can be prevented, so that safety and life characteristics of the battery can be improved.

By setting a to 0.05 or more and 0.5 or less, practical battery performance can be obtained.

By setting b to 0.03 or more and 0.5 or less, practical battery performance can be obtained.

M is only required to include one or more metal elements other than Ni, Co and Mn. M may include, for example, one or more elements selected from the group consisting of Mg, Ca, Al, Ti, V, Cr, Sr, Zr, Nb, Mo, and W.

As described above, the first oxide can realize a battery excellent in energy density, life performance, and safety. On the other hand, the first oxide has a problem about gas generation during charge and discharge. When the electrode containing the first oxide as an active material satisfies the expression (1), gas generation during charge and discharge can be prevented, so that a battery excellent in energy density, life performance, and safety is obtained.

In the first oxide, a preferred range of (1-a-b-c) is 0.6≤(1-a-b-c)≤0.9. By setting the value of (1-a-b-c) within this range, the energy density of the active material can be increased, and therefore the energy density of the electrode can be improved, but gas is likely to be generated during charge/discharge cycles. In the pore size diameter distribution satisfying the expression (1), the preventing effect on gas generation is high when the value of the molar ratio of Ni (1-a-b-c) is 0.6 or more and 0.9 or less. Therefore, by setting the value of the molar ratio of Ni (1-a-b-c) in the first oxide to 0.6 or more and 0.9 or less, the amount of gas generation during charge/discharge cycles can be reduced while a high energy density is achieved.

The first oxide may be in the form of particles. The particles of the first oxide may be, for example, monocrystalline particles, aggregates of monocrystalline particles, or aggregates of polycrystalline particles. The particles of the first oxide may be a mixture in which monocrystalline particles and aggregates of monocrystalline particles exist. The monocrystalline particle is also called a primary particle. The aggregate of monocrystalline particles is also called a secondary particle. Examples of the aggregate of monocrystalline particles include simply aggregated monocrystalline particles, aggregated particles bound together by sintering or the like, and aggregated particles fused together. The aggregate of monocrystalline particles may, or is not required to, have a boundary between the particles. The particles of the first oxide desirably include aggregates of monocrystalline particles. When the particles of the first oxide include aggregates of monocrystalline particles, it is possible to prevent generation of new pores in the electrode due to breakage of the particles of the first oxide when the particles of the first oxide repeat insertion and extraction reactions of Li ions in charge/discharge cycles. As a result, the pore size diameter distribution satisfying the expression (1) can be maintained even when the charge/discharge cycle is repeated, so that gas generation can be prevented over prolonged cycles.

The shape of the particles of the first oxide may be, for example, a granular, fibrous, or scaly.

The active material may contain an additional active material other than the first oxide. The proportion of the first oxide in the active material may be, for example, 70 mass % or more and 100 mass % or less. Examples of the other active material include manganese dioxide (MnO₂), iron oxides, copper oxides, nickel oxides, lithium manganese composite oxides (for example, LiₓMn₂O₄ or LiₓMnO₂; 0>x≤1), lithium nickel composite oxides (for example, LiₓNiO₂; 0<x≤1), lithium-cobalt composite oxides (for example, LiₓCOO₂; 0<x≤1), lithium nickel cobalt composite oxides (for example, LiₓNi_{1-y}CO_{y}O₂; 0<x≤1, 0<y<1), lithium manganese cobalt composite oxides (for example, LiₓMn_{y}Co_{1-y}O₂; 0<x≤1, 0<y<1), lithium manganese nickel composite oxides having a spinel structure (for example, LiₓMn_{2-y}Ni_{y}O₄; 0<x≤1, 0<y<2), lithium phosphorus oxides having an olivine structure (for example, LiₓFePO₄; 0<x≤1, LiₓFe_{1-y}Mn_{y}PO₄; 0<x≤1, 0<y≤1, LiₓCOPO₄; 0<x≤1), iron sulfate (Fe₂ (SO₄)₃), and vanadium oxides (for example, V₂O₅).

As the active material, one species of the compounds listed above may be used. Alternatively, a mixture of two or more of the compounds listed above may be used as the active material.

The average particle size of the active material particles may be, for example, 1 μm or more and 10 μm or less.

The active material-containing layer may contain an electro-conductive agent, and a binder as necessary.

The electro-conductive agent that may be contained in the electrode can act to enhance current collection performance and to prevent contact resistance between the active material and the current collector. Examples of the electro-conductive agent include carbonaceous substances such as acetylene black, carbon black, graphite, carbon nanofibers, and carbon nanotubes. As the carbonaceous substance, one species or two species or more of the above carbonaceous substances may be used.

The binder can act to bind the active material, the electro-conductive agent and the current collector. Examples of the binder include polytetrafluoroethylene (PTFE), polyvinylidene fluoride (PVdF), fluororubber, styrene-butadiene rubber, acrylic resins and copolymers thereof, polyacrylic acid, and polyacrylonitrile.

The proportion of the active material in the electrode material layer (active material-containing layer) may be, for example, 80 mass % or more and 95 mass % or less.

The proportion of the electro-conductive agent in the electrode material layer (active material-containing layer) may be, for example, 3 mass % or more and 18 mass % or less. By setting the amount of the electro-conductive agent to 3 mass % or more, the above effects can be exhibited. By setting the amount of the electro-conductive agent to 18 mass % or less, decomposition of the electrolyte on the surface of the electro-conductive agent under high-temperature storage can be reduced.

The proportion of the binder in the electrode material layer (active material-containing layer) may be, for example, 2 mass % or more and 17 mass % or less. By setting the amount of the binder to 2 mass or more, sufficient electrode strength is obtained. By setting the amount of the binder to 17 mass % or less, the amount of the binder also acted as an insulating material in the electrode can be decreased to reduce the internal resistance.

The electrode can be produced, for example, by the following method. First, the active material, the electro-conductive agent, the binder, and a part of the solvent are added into a stirrer, and stirred with a stirring blade. This process is a first stirring process. In the first stirring process, stirring is performed in a state where the solid content ratio of the slurry (mixture) is high, and therefore the viscosity of the slurry increases. The stirring torque value increases as the stirring proceeds. The maximum value of the stirring torque is T1. When the stirring is further continued, the pulverization of the added materials proceeds, so that the stirring torque value decreases. The stirring torque at this time is T2. At this stage, the remaining solvent is added into the stirrer, and the mixture is further stirred with the stirring blade. This process is a s second stirring process. When the viscosity of the slurry reaches a predetermined value, the second stirring process is terminated. The ratio (%) of the stirring torque value T2 to the maximum value T1 of the stirring torque is a ratio (%) of decrease in stirring torque. By setting the ratio of decrease in stirring torque to 85% or less, the active material, the electro-conductive agent and the binder can be uniformly dispersed because stirring by the first stirring process becomes sufficient. As a result, an active material-containing layer satisfying the expression (1) can be formed. The lower limit value of the ratio of decrease in stirring torque may be, for example, 75%.

The slurry obtained by the second stirring process is applied to one surface or both surfaces of the current collector, and the coating film is dried. Next, the dried coating film is pressed. An electrode including a current collector, and electrode material layer (active an material-containing layer) formed on one surface or both surfaces of the current collector, and satisfying the expression (1) can be thus obtained. The value of B/(A+B) can be set within a predetermined range by adjusting, for example, electrode materials such as an active material, the solid content ratio of the slurry in the first stirring process, and a ratio of decrease in stirring torque. On the other hand, the ratio of the pore volume (A+B) to the pore volume (C) can be set within a predetermined range by adjusting, for example, the solid content ratio of the slurry in the second stirring process. If the solid content ratio of the slurry in the second stirring process is high, the viscosity of the slurry increases. If the viscosity of the slurry is high, the shape of irregularities on the surface of the slurry layer applied to the current collector is unlikely to collapse, and drying proceeds in a state where the surface of the slurry layer is rougher. As a result, the number of irregularities on the surface of the electrode material layer increases, so that the ratio of the pore volume (A+B) to the pore volume C can be reduced. On the other hand, if the solid content ratio of the slurry in the second stirring process is low, the viscosity of the slurry decreases. If the viscosity of the slurry is low, the shape of irregularities on the surface of the slurry layer on the current collector collapses, and the surface of the slurry layer becomes smoother, followed by drying. As a result, the number of irregularities on the surface of the electrode material layer decreases, so that the ratio of the pore volume (A+B) to the pore volume C can be increased.

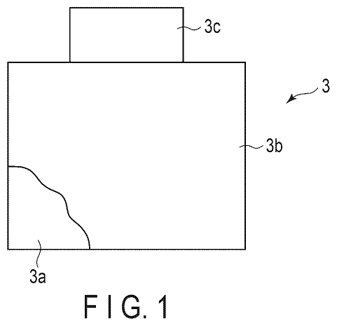

FIG. 1 is a partially cutaway plan view schematically showing an example of the electrode according to the embodiment. Here, as an example of the electrode, an exemplar positive electrode is illustrated.

A positive electrode 3 shown in FIG. 1 includes a positive electrode current collector 3a, and a positive electrode active material-containing layer 3b provided on a surface of the positive electrode current collector 3a. The positive electrode active material-containing layer 3b is supported on a: surface of the positive electrode current collector 3a. The positive electrode current collector 3a includes a portion where the positive electrode active material-containing layer 3b is not provided on the surface thereof. This portion serves, for example, as a positive electrode current-collecting tab 3c. In the illustrated example, the positive electrode current-collecting tab 3c is a narrow portion having a width smaller than that of the positive electrode active material-containing layer 3b. The width of the positive electrode current-collecting tab 3c may be smaller than the width of the positive electrode active material-containing layer 3b as described above, or may be the same as the width of the positive electrode active material-containing layer 3b. Instead of the positive electrode current-collecting tab 3c which is a part of the positive electrode current collector 3a, electrically conductive member as a separate body may be electrically connected to the positive electrode 3, and used as an electrode current-collecting tab (positive electrode current-collecting tab).

Methods for measuring the pore size diameter distribution and the composition of the active material will be described below.

### <Extraction of Electrode>

In a case where an electrode to be measured is incorporated in a battery, the electrode as a measurement sample is taken out from the battery as below. The battery is discharged, and disassembled in a glove box in an argon atmosphere, and the electrode is taken out. The electrode is washed with diethyl carbonate, and subjected to vacuum drying. In this way, the measurement sample is obtained.

### <Method for Measuring Mercury Intrusion Pore Volume Distribution of Active Material-Containing Layer>

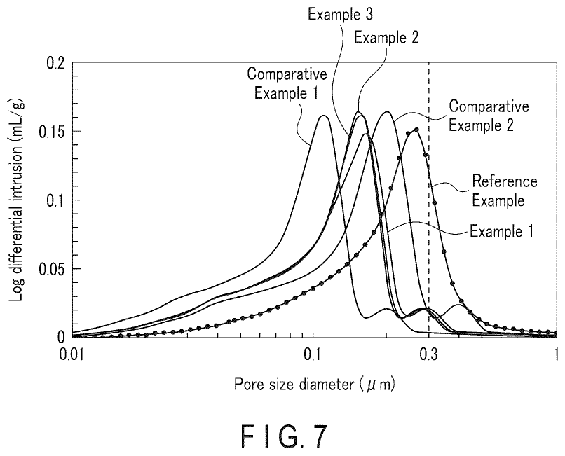

The electrode obtained by the above method may be used as a sample. As a pore size diameter distribution measuring apparatus, AutoPore 9520 manufactured by Shimadzu Corporation is used. In the measurement, the sample is cut into a size of about 25 mm in width, folded, put into a standard cell, and inserted into a measurement chamber. The measurement is performed under conditions of an initial pressure of 20 kPa (about 3 psia, corresponding to a pore size diameter of about 60 μm) and a final pressure of 414,000 kPa (about 60,000 psia, corresponding to a pore size diameter of about 0.003 μm). In the mercury intrusion pore size diameter distribution, pore size diameters not only of the active material-containing layer but also of the electrode current collector exist. However, the pore size diameter of the current collector can be ignored because it is sufficiently smaller than the pore size diameter of the active material-containing layer, and the abundance ratio of the pores in the current collector is small. The pore volume is calculated using a graph of a pore size diameter distribution obtained. An example of graphs of pore size diameter distributions is shown in FIG. 7.

### <Confirmation of Lithium/Nickel/Cobalt/Manganese-Containing Oxide>

Whether a lithium/nickel/cobalt/manganese-containing oxide is contained or not can be confirmed by identifying an active material contained in the electrode in the following manner.

The electrode taken out from the battery is washed and dried as described above, and the obtained electrode is then bonded to a glass sample plate. Here, in performing the treatment, care is taken to prevent peeling and floatation of the electrode by use of a double-sided tape or the like. If necessary, the electrode may be cut into a size appropriate for application to a glass sample plate. A Si standard sample for correcting the peak position may be added onto the electrode.

Next, the glass plate to which the electrode is bonded is placed in a powder X-ray diffraction (XRD) apparatus, and a diffraction pattern is obtained using a Cu-Ko ray. An X-ray diffraction pattern can be obtained by performing measurement by using a Cu-Ko ray as a radiation source and changing 20 within a measurement range of 5 to 90°.

As an apparatus for powder X-ray diffraction measurement, for example, SmartLab manufactured by Rigaku Corporation is used. The measurement conditions are as follows:
X-ray source: Cu target
Output: 45 kV, 200 mA
Soller slit: 5° for both incidence and light reception
Step width: 0.02 deg
Scan speed: 20 deg/min
Semiconductor detector: D/tex Ultra 250
Sample plate holder: flat glass sample plate holder (thickness 0.5 mm)
Measurement range: range of 5°≤2θ≤90°.

In a case where another apparatus is used, measurement using a standard Si powder for powder X-ray diffraction is performed so as to obtain measurement results equivalent to those described above, conditions under which the peak intensity is equivalent to the results obtained with the above apparatus and the peak top position that is coincide with those with the above apparatus are found, and the conditions are used for the measurement of the sample.

In a case where an active material to be measured contains a lithium/nickel/cobalt/manganese-containing oxide, it can be confirmed by X-ray diffraction measurement that an X-ray diffraction pattern attributed to the space group R3-m is obtained.

Subsequently, the sample containing an active material is observed with a scanning electron microscope (SEM). The SEM observation is desirably performed after handling in an inert gas atmosphere of argon, nitrogen or the like so that the sample taken out from the battery does not come into contact with the air.

Some particles in the form of primary particles or secondary particles, which are confirmed in the field of view, are selected in a SEM observation image magnified 3,000 times. Here, the particles are selected so that the particle size distribution of the selected particles is as wide as possible. For the active material particles that have been observed, the types and the composition of constituent elements of the active material are identified by energy dispersive X-ray spectroscopy (EDX). By this, the types and amounts of elements other than Li among the elements contained in each of the selected particles can be identified. A similar operation is performed on each of plural active material particles to determine a mixed state of the active material particles.

Subsequently, for example, the electrode material layer (active material-containing layer) is separated from the current collector with a spatula or the like to obtain a powdered electrode material sample containing the active material. The collected powder sample is washed with acetone, and dried. The obtained powder is dissolved in hydrochloric acid, the electro-conductive agent is removed by filtration, and dilution with ion-exchanged water is then performed to prepare a measurement sample. The metal content ratio in the measurement sample is calculated by inductively coupled plasma atomic emission spectroscopy (ICP-AES).

In a case where there are plural types of active materials, a mass ratio thereof is estimated from a content ratio of elements specific to the respective active materials. The ratio of the masses of the specific element and the active material is determined from the composition of the constituent elements which is obtained by energy dispersive X-ray spectroscopy.

The active material contained in the electrode can be thus identified.

### <Method for Confirming Monocrystalline Particles>

Whether the active material is monocrystalline particles can be confirmed, for example, by analyzing an electron beam diffraction image with a transmission electron microscope (TEM).

The electrode of the first embodiment described above contains an active material containing an oxide represented by a general formula LiₓNi_{1-a-b-c}COₐMn_{b}M_{c}O₂ (wherein x, a, b, and c satisfy 0.9≤x≤1.25, 0.05≤a≤0.5, 0.03≤b≤0.5, and 0≤c≤0.2; and M includes one or more metal elements other than Ni, Co and Mn). The electrode satisfies the expression (1).

$$0.001 < B / ( A + B ) \leq 0.09 \qquad ( 1 )$$

The electrode is capable of improving the capacity, and reducing the amount of gas generation during charge/discharge cycles. Thus, the charge/discharge cycle life can be improved.

### Second Embodiment

According to a second embodiment, a battery including a positive electrode, a negative electrode, and an electrolyte is provided. At least one of the positive electrode or the negative electrode is the electrode of the embodiment.

Examples of the battery according to the embodiment include a secondary battery such as a lithium ion secondary battery. The secondary battery includes a nonaqueous electrolyte secondary battery containing a nonaqueous electrolyte.

The battery may include a separator, a container member, or both. The positive electrode, the negative electrode and the separator can form an electrode group. The electrolyte may be held in the electrode group. The battery may further include a container member that houses the electrode group and the electrolyte. Further, the battery may further include a positive electrode terminal electrically connected to the positive electrode and a negative electrode terminal electrically connected to the negative electrode. At least a part of the positive electrode terminal and at least a part of the negative electrode terminal may be drawn outside the container member.

### (Positive Electrode)

The positive electrode may include, for example, a positive electrode current collector and a positive electrode material layer (positive electrode active material-containing layer).

The electrode of the first embodiment may be used as the positive electrode.

### (Negative Electrode)

The negative electrode may include a negative electrode current collector and a negative electrode material layer (negative electrode active material-containing layer). The negative electrode material layer (negative electrode active material-containing layer) may be formed, for example, on one surface or both a surface and a back surface of the negative electrode current collector. The current collector has, for example, a band shape or a sheet shape. The negative electrode material layer (negative electrode active material-containing layer) may contain a negative electrode active material, and optionally an electro-conductive agent and a binder.

Examples of the negative electrode active material include metal oxides, carbonaceous materials, and metal compounds. The species of the negative electrode active material may be one species or two species or more.

Examples of the carbonaceous material include natural graphite, artificial graphite, coke, vapor-grown carbon fibers, mesophase pitch-based carbon fibers, spherical carbon, and resin-fired carbon. Examples of the more preferred carbonaceous material include vapor-grown carbon fibers, mesophase pitch-based carbon fibers, and spherical carbon. The carbonaceous material preferably has a (002) plane spacing d₀₀₂ of 0.34 nm or less as measured by X-ray diffraction.

As the metal compound, a metal sulfide or a metal nitride may be used. As the metal sulfide, titanium sulfide such as TiS₂, molybdenum sulfide such as MoS₂, or iron sulfide such as FeS, FeS₂ or LiₓFeS₂ may be used. As the metal nitride, for example, lithium cobalt nitride (for example, LiₛCoₜN, 0<s<4, 0<t<0.5) may be used.

Examples of the metal oxide include titanium-containing oxides. Examples of the titanium-containing oxide include lithium titanium-containing oxides (lithium titanium composite oxides) and niobium titanium-containing oxides (niobium titanium composite oxides). The titanium-containing oxide preferably includes a lithium titanium composite oxide. An electrode containing a titanium-containing oxide such as a lithium titanium composite oxide can exhibit a Li insertion potential of 0.4 V (vs. Li/Li⁺) or more as a value with respect to the oxidation-reduction potential of lithium, so that the deposition of metallic lithium on the electrode surface in repetition of input and output at a large current can be prevented. The titanium-containing oxide particularly preferably includes a lithium-titanium composite oxide having a spinel-type crystal structure. Specific examples of the spinel-type lithium-titanium composite oxide include a lithium titanium oxide having a spinel structure, which is represented by Li₄₊ₐTi₅O₁₂, where the value of the subscript a changes within a range of 0≤a≤3 depending on charge and discharge.

Examples of the niobium titanium-containing oxide include niobium titanium-containing oxides having a monoclinic structure. Examples of the niobium titanium-containing oxide having a monoclinic structure include Nb₂TiO₇, Nb₂Ti₂O₉, Nb₁₀T1₂O₂₉, Nb₁₄TiO₃₇ and Nb₂₄TiO₆₂.

The active material may be in the form of, for example, particles, or fibers. The active material particles may be primary particles, secondary particles, or a mixture of primary particles and secondary particles. Examples of the secondary particle include aggregates of primary particles.

The active material may contain an additional active material other than the titanium-containing oxide. Here, the active material containing a titanium-containing oxide may be referred to as a “first active material” for convenience, and the other active material may be referred to as a “second active material”. In a case where the second active material is further contained in addition to the first active material, an active material capable of exhibiting a Li insertion potential of 0.4 V (vs. Li/Li⁺) or more is desirably used as the second active material. In a case where the second active material is contained, the mass ratio of the second active material to the first active material is preferably 5 mass % or more and 40 mass % or less, and more preferably 10 mass % or more and 30 mass % or less.

The electro-conductive agent can act to enhance the current-collecting performance and to prevent a contact resistance between the active material and the current collector. Examples of the electro-conductive agent include carbonaceous substances such as acetylene black, carbon black, graphite, carbon nanofibers, and carbon nanotubes. One of the carbonaceous substances may be used alone, or two or more thereof may be used.

The binder can act to bind the active material, the electro-conductive agent and the current collector. Examples of the binder include polytetrafluoroethylene (PTFE), polyvinylidene fluoride (PVdF), fluororubber, styrene-butadiene rubber, acrylic resins and copolymers thereof, polyacrylic acid, and polyacrylonitrile.

The proportion of the negative electrode active material in the negative electrode material layer (negative electrode active material-containing layer) may be, for example, 70 mass % or more and 97.5 mass % or less.

The proportion of the electro-conductive agent in the negative electrode material layer (negative electrode active material-containing layer) may be, for example, 2 mass % or more and 20 mass % or less. By setting the amount of the electro-conductive agent to 2 mass % or more, the current-collecting performance of the electrode material layer (active material-containing layer) is improved, and excellent performance at a large current and excellent performance at a low temperature can be expected. On the other hand, from the viewpoint of increasing the capacity, the amount of the electro-conductive agent is preferably 20 mass % or less.

The proportion of the binder in the negative electrode material layer (negative electrode active material-containing layer) may be, for example, 0.5 mass % or more and 10 mass % or less. When the amount of the binder is 0.5 mass % or more, the binding between the electrode material layer (active material-containing layer) and the current collector becomes sufficient, and excellent storage performance at a high temperature can be expected. On the other hand, from the viewpoint of increasing the capacity, the amount of the binder is preferably 10 mass % or less.

A current collector suitable for the type of the negative electrode active material may be used. The negative electrode current collector can contain, for example, at least one element of copper, nickel and aluminum. The negative electrode current collector may be in the form of, for example, a foil or a porous material. In a case where the negative electrode active material contains a titanium-containing oxide, the negative electrode current collector is preferably formed from an aluminum foil, or an aluminum alloy foil containing elements such as Mg, Ti, Zn, Mn, Fe, Cu or Si. The thickness of the current collector is preferably 20 μm or less, and more preferably 15 μm or less.

### (Separator)

The separator can be disposed, for example, between the positive electrode and the negative electrode. The separator may include a portion contacting or facing only one of the positive electrode and the negative electrode.

The separator is not particularly limited. For example, a microporous film, a woven fabric, a nonwoven fabric, or a stack of the same material or different materials among the foregoing materials. Examples of the material for forming the separator include polyethylene, polypropylene, ethylene-propylene copolymers, ethylene-butene copolymers, and cellulose.

### (Nonaqueous Electrolyte)

Examples of the electrolyte include nonaqueous electrolytes. As the nonaqueous electrolyte, for example, a liquid nonaqueous electrolyte or a gel nonaqueous electrolyte may be used.

The liquid nonaqueous electrolyte can be prepared by dissolving an electrolyte in an organic solvent. The concentration of the electrolyte is preferably in a range of 0.5 to 3 mol/l. The gel nonaqueous electrolyte is prepared by combining a liquid electrolyte and a polymer material.

Examples of the electrolyte include lithium salts such as lithium perchlorate (LiClO₄), lithium hexafluorophosphate (LiPE₆), lithium tetrafluoroborate (LiBF₄), lithium hexafluoroarsenate (LiAsF₆), lithium trifluoromethanesulfonate (LiCF₃SO₃), and lithium bistrifluoromethylsulfonylimide [LIN(CF₃SO₂)₂]. As the electrolyte, one species of the above electrolytes may be used, or two species or more of the electrolytes may be used in combination. The electrolyte preferably includes LiPF₆.

Examples of the organic solvent include cyclic carbonates such as propylene carbonate (PC), ethylene carbonate (EC) and vinylene carbonate; chain carbonates such as diethyl carbonate (DEC), dimethyl carbonate (DMC) and methylethyl carbonate (MEC); cyclic ethers such as tetrahydrofuran (THF), 2-methyltetrahydrofuran (2MeTHF) and dioxolane (DOX); chain ethers such as dimethoxyethane (DME) and diethoxyethane (DEE); acetonitrile (AN), γ-butyllactone (GBL), and sulfolane (SL). As the organic solvent, one species of the above solvents may be used alone, or two species or more of the solvents may be used in combination.

Examples of the more preferred organic solvent include mixed solvents obtained by mixing two or more selected from the group consisting of propylene carbonate (PC), ethylene carbonate (EC), diethyl carbonate (DEC), dimethyl carbonate (DMC), and methylethyl carbonate (MEC). By using such a mixed solvent, a nonaqueous electrolyte battery having excellent charge/discharge cycle characteristics can be obtained. Additives can be added to the nonaqueous electrolyte.

### (Container Member)

As the container member, for example, a bag-shaped container made of a laminate film, or a metal container may be used.

The shape is not particularly limited, and examples thereof include a flat type, a prismatic type, a cylindrical type, a coin type, a button type, a sheet type, and a stacked type. Of course, in addition to a small-sized battery installed in a portable electronic device or the like, large-sized battery installed in a two-wheeled to four-wheeled automobile or the like may be covered.

As the laminate film, for example, a multilayer film in which a metal layer is sandwiched between resin films may be used. Alternatively, a multilayer film including a metal layer and a resin layer covering the metal layer may be used.

As the metal layer, an aluminum foil or an aluminum alloy foil is preferably used for weight reduction. For example, a polymer material such as polypropylene (PP), polyethylene (PE), nylon, or polyethylene terephthalate (PET) may be used for the resin layer. The laminate film can be molded into the shape of the container member by sealing with thermal fusion bonding. The laminate film preferably has a wall thickness of 0.2 mm or less.

The metal container can be formed from aluminum or an aluminum alloy. The aluminum alloy preferably contains elements such as magnesium, zinc or silicon. On the other hand, the content of transition metals such as iron, copper, nickel or chromium is preferably 100 ppm or less. By this, long-term reliability in a high-temperature environment, and heat dissipation can be dramatically improved. The metal container preferably has a wall thickness of 0.5 mm or less, and more preferably has a wall thickness of 0.2 mm or less. The metal container can also serve as a positive electrode terminal or a negative electrode terminal.

### (Positive Electrode Terminal)

The positive electrode terminal is preferably formed of a material that is electrically stable in a potential range of, for example, 3.0 V or more and 4.5 V or less with respect to the oxidation-reduction potential of lithium, and has electrical conductivity. The positive electrode terminal is preferably formed from aluminum, or an aluminum alloy containing elements such as Mg, Ti, Zn, Mn, Fe, Cu or Si. The positive electrode terminal is preferably formed from the same material as the material of the positive electrode current collector for reducing contact resistance with the positive electrode current collector. The positive electrode terminal and the positive electrode current collector can connect to, for example, a positive electrode lead through a positive electrode current-collecting tab. The positive electrode current-collecting tab is preferably formed from the same material as the material of the positive electrode terminal and the material of the positive electrode current collector.

### (Negative Electrode Terminal)

The negative electrode terminal is preferably formed of a material that is electrically stable in a potential range of 0.8 V or more and 3.0 V or less with respect to the oxidation-reduction potential of lithium, and has electrical conductivity. The negative electrode terminal is preferably formed from aluminum, or an aluminum alloy containing elements such as Mg, Ti, Zn, Mn, Fe, Cu or Si. The negative electrode terminal is preferably formed from the same material as the material of the negative electrode current collector for reducing contact resistance with the negative electrode current collector. The negative electrode terminal and the negative electrode current collector can connect to, for example, a negative electrode lead through a negative electrode current-collecting tab. The negative electrode current-collecting tab is preferably formed from the same material as the material of the negative electrode terminal and the material of the negative electrode current collector.

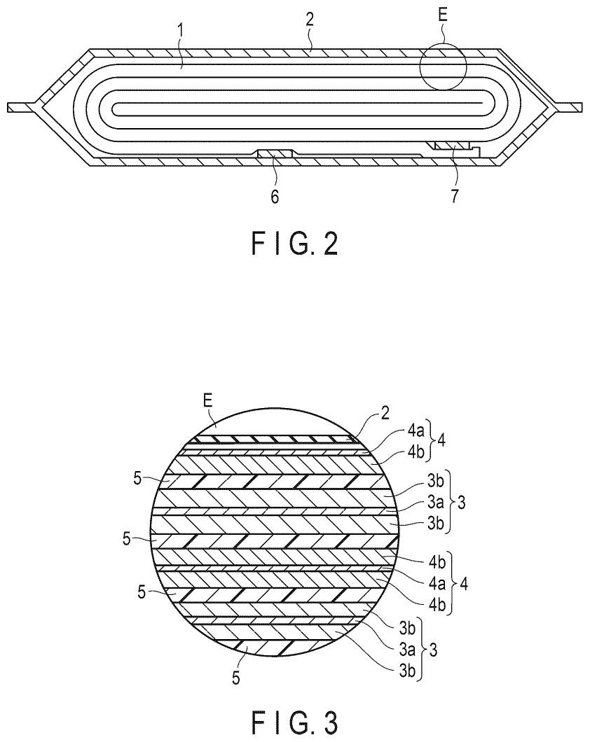

An example of the battery of the embodiment will be described with reference to FIGS. 2 and 3. The flat-type battery shown in FIG. 2 includes a flat-shaped wound electrode group 1, a container member 2, a positive electrode terminal 7, a negative electrode terminal 6, and an electrolyte (not shown). The container member 2 is a bag-shaped container member including a laminate film. The wound electrode group 1 is housed in the container member 2. As shown in FIG. 3, the wound electrode group 1 includes a positive electrode 3, a negative electrode 4, and a separator 5, and is formed by spirally winding and press-molding a stack in which the negative electrode 4, the separator 5, the positive electrode 3 and the separator 5 are stacked in the stated order from the outside.

The positive electrode 3 includes a positive electrode current collector 3a and a positive electrode active material-containing layer 3b. The positive electrode active material-containing layer 3b contains a positive electrode active material. The positive electrode active material-containing layer 3b is formed on both surfaces of the positive electrode current collector 3a. The negative electrode 4 includes a negative electrode current collector 4a and a negative electrode active material-containing layer 4b. The negative electrode active material-containing layer 4b contains a negative electrode active material. At a portion of the negative electrode 4 which is located on the outermost side, the negative electrode active material-containing layer 4b is formed only on one surface of the negative electrode current collector 4a on the inner side. At other portions of the negative electrode 4, the negative electrode active material-containing layer 4b is formed on both surfaces of the negative electrode current collector 4a.

As shown in FIG. 3, in the vicinity of the outer peripheral edge of the wound electrode group 1, a positive electrode terminal 7 is connected to the positive electrode 3. The negative electrode terminal 6 is connected to the negative electrode 4 in the outermost layer. The positive electrode terminal 7 and the negative electrode terminal 6 extend to the outside through an opening of the container member 2.

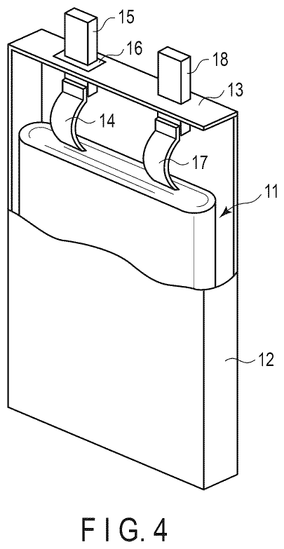

The battery is not limited to a battery having the configuration shown in FIGS. 2 and 3, and may have, for example, a configuration shown in FIG. 4.

In a prismatic battery shown in FIG. 4, a wound electrode group 11 is housed in a bottomed rectangular cylinder-shaped container 12 made of metal, which is a container member. A rectangular lid body 13 is welded at the opening of the container 12. The flat wound electrode group 11 may have the same configuration as the wound electrode group 1 described with reference to FIGS. 2 and 3.

One end of a negative electrode tab 14 is electrically connected to the negative electrode current collector, and the other end is electrically connected to a negative electrode terminal 15. The negative electrode terminal 15 is fixed to the rectangular lid body 13 by hermetic sealing with a glass material 16 interposed therebetween. One end of a positive electrode tab 17 is electrically connected to the positive electrode current collector, and the other end is electrically connected to a positive electrode terminal 18 fixed to the rectangular lid body 13.

The negative electrode tab 14 is produced from, for example, a material such as copper, nickel, aluminum, or an aluminum alloy containing elements such as Mg, Ti, Zn, Mn, Fe, Cu, or Si. The negative electrode tab 14 is preferably made of the same material as the negative electrode current collector for reducing contact resistance with the negative electrode current collector.

The positive electrode tab 17 is produced from, for example, a material such as aluminum, or an aluminum alloy containing elements such as Mg, Ti, Zn, Mn, Fe, Cu, or Si. The positive electrode tab 17 is preferably made of the same material as the positive electrode current collector for reducing contact resistance with the positive electrode current collector.

In the illustrated battery, a wound electrode group in which a separator is wound together with a positive electrode and a negative electrode is used, but the structure of the electrode group is not particularly limited. For example, a stacked electrode group obtained by folding a separator in zigzag, and alternately arranging a positive electrode and a negative electrode at folded points, or a stacked electrode group obtained by alternately arranging a positive electrode and a negative electrode with a separator interposed therebetween may be used.

The battery according to the first embodiment includes the electrode of the first embodiment as at least one of a positive electrode or a negative electrode. Therefore, the battery capacity can be improved, and the amount of gas generation during charge/discharge cycles can be reduced.

### Third Embodiment

According to a third embodiment, a battery pack is provided. The battery pack includes the battery according to the embodiment.

The battery pack according to the embodiment may include one or more batteries (unit cells) according to the embodiment described above. The plural batteries that may be included in the battery pack can be electrically connected in series or in parallel to form battery module. The battery pack may include plural battery modules.

Next, an exemplar battery pack according to the embodiment will be described with reference to the drawings.

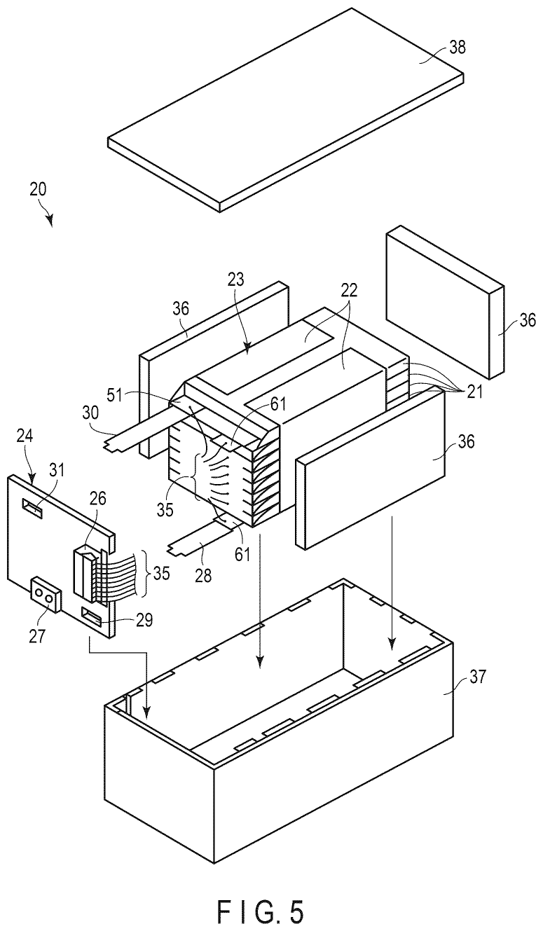

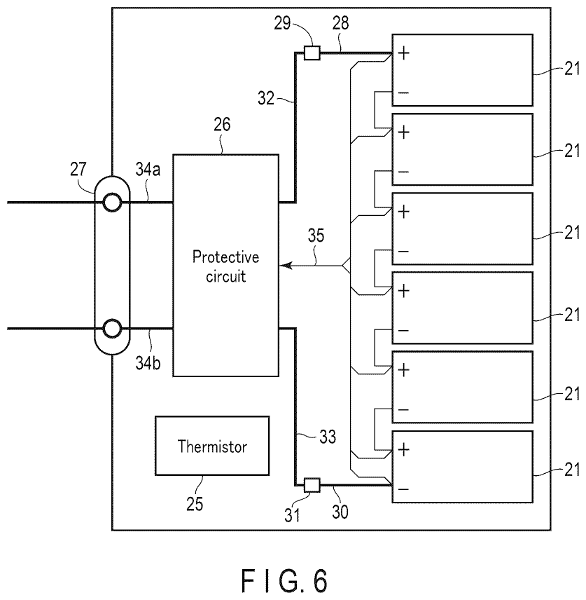

FIG. 5 is an exploded perspective view of an exemplar battery pack according to the embodiment. FIG. 6 is a block diagram showing an electric circuit of the battery pack of FIG. 5.

A battery pack 20 shown in FIGS. 5 and 6 includes plural single-batteries 21. The single-battery 21 may be the exemplar flat battery according to the embodiment which is described with reference to FIG. 2.

The plural single-batteries 21 are stacked so that negative electrode terminals 51 and positive electrode terminals 61 extending outside are aligned in the same direction and are fastened with an adhesive tape 22 to configure a battery module 23. These single-batteries 21 are electrically connected in series with each other as shown in FIG. 6.

A printed wiring board 24 is disposed facing the side surface from which the negative electrode terminals 51 and the positive electrode terminals 61 of the single-batteries 21 extend. On the printed wiring board 24, a thermistor 25, a protective circuit 26, and a terminal 27 for power distribution to external apparatuses are mounted as shown in FIG. 6. Note that an insulating plate (not shown) is attached to the surface of the printed wiring board 24, which faces the battery module 23, so as to avoid unnecessary connection with the wiring of the battery module 23.

A positive electrode side lead 28 is connected to the positive electrode terminal 61 located lowermost in the battery module 23, and its tip is inserted into a positive electrode side connector 29 of the printed wiring board 24 and electrically connected thereto. A negative electrode side lead 30 is connected to the negative electrode terminal 51 located uppermost in the battery module 23, and its tip is inserted into the negative electrode side connector 31 of the printed wiring board 24 and electrically connected thereto. These connectors 29 and 31 are connected to the protective circuit 26 through wiring 32 and the wiring 33 formed on the printed wiring board 24.

The thermistor 25 detects the temperature of the single-batteries 21, and the detection signal is transmitted to the protective circuit 26. The protective circuit 26 can shut off a plus-side wiring 34a and a minus-side wiring 34b between the protective circuit 26 and the terminal 27 for power distribution to external apparatuses in accordance with a predetermined condition. An example of the predetermined condition is, for example, when the temperature detected by the thermistor 25 becomes a predetermined temperature or higher. Another example of the predetermined condition is when overcharge, over-discharge, overcurrent, or the like of the single-battery 21 is detected. Detection of the overcharge or the like is performed for each of the individual single-batteries 21 or the entire battery module 23. In the case of detecting each single-battery 21, a battery voltage may be detected, or a positive electrode potential or a negative electrode potential may be detected. In the latter case, a lithium electrode used as a reference electrode is inserted into each single-battery 21. For the battery pack 20 of FIG. 5 and FIG. 6, wiring 35 for voltage detection is connected to each of the single-batteries 21. Detection signals are transmitted to the protective circuit 26 through the wiring 35.

Protective sheets 36 made of rubber or resin are respectively arranged on three side surfaces of the battery module 23 excluding the side surface from which the positive electrode terminal 61 and the negative electrode terminal 51 protrude.

The battery module 23 is housed in a housing container 37 together with each protective sheet 36 and the printed wiring board 24. Namely, the protective sheets 36 are disposed in the housing container 37 respectively on both inner side surfaces along a long-side direction and an inner side surface along a short-side direction, and the printed wiring board 24 is disposed on the inner side surface along the short-side direction on the opposite side. The battery module 23 is located in a space surrounded by the protective sheets 36 and the printed wiring board 24. A lid 38 is attached to the upper surface of the housing container 37.

For fixing the battery module 23, a thermal shrinkage tape may be used in place of the adhesive tape 22. In this case, after the protective sheets are disposed on each side surface of the battery module and a thermal shrinkage tape is wound, the thermal shrinkage tape is thermally shrunk, to bind the battery module.

While FIG. 5 and FIG. 6 show a form where the single-batteries 21 are electrically connected in series, the single-batteries 21 may be connected in parallel in order to increase the battery capacity. Further, assembled battery packs may also be electrically connected in series and/or parallel.

The mode of the battery pack is appropriately changed depending on the application. A preferable application of the battery pack is one where good cycle performance is desired when a large current is extracted. Specific examples of the applications include that for a power source of a digital camera, and for use in a vehicle such as a two-wheeled to four-wheeled hybrid electric automobile, a two-wheeled to four-wheeled electric automobile, and a power-assisted bicycle. The battery pack is particularly preferably used for on-board applications.

The battery pack according to the second embodiment includes the battery according to the first embodiment. Therefore, in the battery pack, the battery capacity can be improved, and the amount of gas generation during charge/discharge cycles can be reduced.

### EXAMPLES

Hereinafter, examples will be described; however, as long as the scope of the present invention is not exceeded, the present invention is not limited to the examples given below.

### Example 1

In Example 1, a nonaqueous electrolyte battery of Example 1 was produced by the following procedure.

### (Production Method for Positive Electrode)

As a positive electrode active material, aggregates of monocrystalline particles of a lithium nickel cobalt manganese composite oxide represented by a general formula LiₓNi_{1-a-b-c}COₐM_{b}M_{c} (wherein x is 0.98, 1-a-b-c is 0.80, a is 0.10, b is 0.10 and c is 0.) were prepared.

The positive electrode active material, polyvinylidene fluoride as a binder, and acetylene black as an electro-conductive agent were prepared at a mixing ratio of 100 parts by mass (93 mass %): 2 parts by mass (2 mass %): 5 parts by mass (5 mass %). The positive electrode active material, the binder, the electro-conductive agent and N-methylpyrrolidone (NMP) were added into a planetary mixer. The solid content ratios to all the added materials are shown in Table 2. All the added materials were stirred with the planetary mixer to carry out a first stirring process. In the stirring, the operating current of a stirring blade was monitored as a stirring torque. After the operating current of the stirring blade increased to a maximum current value (5.9 A) after the start of stirring, stirring was further performed for 50 minutes to obtain an intermediate slurry. The operating current value (4.9 A) of the stirring blade at this time was a stirring torque value T2. The reduction rate (%) of the stirring torque, which was determined from the ratio (%) of the stirring torque value T2 to the maximum value T1 of the stirring torque (maximum current value), was 83%.

Next, N-methylpyrrolidone (NMP) was added to the intermediate slurry, so that the solid content ratio to all materials (referred to as a second stirring solid content ratio) was 64 mass %. The mixture was stirred with a planetary mixer to carry out a second stirring process, thereby obtaining a slurry.

The slurry was applied to both surfaces of the current collector made of an aluminum foil, and the coating film was dried. Further, the dried coating film was subjected to roll pressing. A positive electrode including a current collector and a positive electrode active material-containing layer formed on both surfaces of the current collector and having an electrode density (excluding the current collector) of 3.3 g/cm3 was thus produced.

### (Production Method for Negative Electrode)

As a negative electrode active material, a lithium titanium oxide having a spinel structure, which is represented by Li₄Ti₅O₁₂, was prepared. A negative electrode active material, polyvinylidene fluoride as a binder, graphite as an electro-conductive agent, and N-methylpyrrolidone (NMP) as a solvent were mixed to produce a slurry. The mixing ratio of the negative electrode active material, the binder and the electro-conductive agent was 100 parts by mass (94 mass %): 2 parts by mass (2 mass %): 4 parts by mass (4 mass %). The obtained slurry was applied to an aluminum foil as a current collector, and dried, and press-molding was then performed so that the electrode density (excluding the current collector) was 2.2 g/cm³, thereby obtaining a negative electrode.

### <Production of Electrode Group>

The positive electrode and the negative electrode produced as described above were stacked with a cellulose separator therebetween to obtain a stacked electrode group. A positive electrode terminal and a negative electrode terminal were connected with the electrode group.

### (Preparation of Liquid Nonaqueous Electrolyte)

As a mixed solvent, a mixed solvent of propylene carbonate and diethyl carbonate (volume ratio 1:2) was prepared. Lithium hexafluorophosphate (LiPF₆) was dissolved in the solvent at a concentration of 13.3 mass %. A liquid nonaqueous electrolyte was thus prepared.

### <Assembly>

The electrode group and the liquid nonaqueous electrolyte produced as described above were housed in a metal container, and the container was sealed to obtain a nonaqueous electrolyte secondary battery.

### Example 2 to 8 and Comparative Examples 1 and 2

A nonaqueous electrolyte secondary battery was produced by the same method as in Example 1 except that the solid content ratio of the intermediate slurry in the first stirring process, the reduction rate of the stirring torque in the first stirring process, and the second stirring solid content ratio were set as shown in Table 2 below.

### Example 9

As a positive electrode active material, aggregates of polycrystal particles of a lithium nickel cobalt manganese composite oxide represented by a general formula LiₓNi_{1-a-b-c}CoₐMn_{b}M_{c} (wherein x is 0.98, 1-a-b-c is 0.80, a is 0.10, b is 0.10 and c is 0) were prepared. The solid content ratio of the intermediate slurry in the first stirring process, the reduction rate of the stirring torque in the first stirring process, and the solid content ratio in the second stirring were set as shown in Table 2 below. Except above, the same method as in Example 1 was carried out to produce a nonaqueous electrolyte secondary battery.

The mercury intrusion pore size diameter distributions of the positive electrodes of Examples and Comparative Examples were measured by the above-described method. Table 1 shows, for each of the obtained pore size diameter distributions, a pore volume A (mL/g) in a pore size diameter range of 0.01 μm or more and 0.3 μm or less, a pore volume B (mL/g) in a pore size diameter range of more than 0.3 μm and 1 μm or less, B/(A+B), a ratio of a pore volume (A+B) (mL/g) to a pore volume C (mL/g) in a pore size diameter range of 0.01 μm or more and 60 μm or less, and a pore size diameter (μm) at a peak top of a maximum peak.

The nonaqueous electrolyte secondary battery produced in each of examples and comparative examples was evaluated by the following procedure.

### <Measurement of 1C Discharge Capacity>

For the secondary battery, a capacity as a 1C discharge capacity was confirmed by the following procedure. First, the secondary battery was charged at a constant current (charged at CC) of 1C to a battery voltage of 2.75 V, and then charged at a constant voltage (charged at CV) of 2.75 V over 2 hours. In the confirmation of the 1C discharge capacity, the secondary battery in this state was discharged at a constant current of 1C to a battery voltage of 1.5 V, and the discharge capacity in this discharge was a 1C discharge capacity.

### <Cycle Test>

The secondary battery whose 1C discharge capacity was measured by the above procedure was charged and discharged at a current value of 3C in a thermostatic bath at 75° C. After 600 cycles, the battery was taken out, the capacity was confirmed at 25° C., and the amount of gas generation shown in Table 1 was calculated.

TABLE 1

| | Pore | Pore | | Pore size | 0.01 to 60 mm | Ratio (%) of | Amount of |
|---|---|---|---|---|---|---|---|
| | volume | volume | | diameter at | Pore | pore volume | gas |
| | A | B | | peak | volume | (A+B) to pore | generation |
| | (mL/g) | (mL/g) | B/ (A+B) | top (mm) | C (mL/g) | volume C | (mL) |
| Example 1 | 0.0627 | 0.0018 | 0.028 | 0.16 | 0.0772 | 85 | 7.8 |
| Example 2 | 0.0614 | 0.0015 | 0.024 | 0.15 | 0.0760 | 84 | 6.3 |
| Example 3 | 0.0627 | 0.0021 | 0.033 | 0.16 | 0.0782 | 84 | 7.7 |
| Example 4 | 0.0619 | 0.0024 | 0.037 | 0.17 | 0.0765 | 85 | 7.8 |
| Example 5 | 0.0697 | 0.0060 | 0.079 | 0.15 | 0.0874 | 88 | 7.6 |
| Example 6 | 0.0680 | 0.0007 | 0.010 | 0.14 | 0.0770 | 89 | 7.9 |
| Example 7 | 0.0614 | 0.0015 | 0.024 | 0.15 | 0.0839 | 75 | 7.1 |
| | Pore | Pore | | Pore size | 0.01 to 60 mm | Ratio (%) of | Amount of |
| | volume | volume | | diameter at | Pore | pore volume | gas |
| | A | B | | peak | volume | (A+B) to pore | generation |
| | (mL/g) | (mL/g) | B/ (A+B) | top (mm) | C (mL/g) | volume C | (mL) |
| Example 8 | 0.0614 | 0.0015 | 0.024 | 0.15 | 0.0662 | 95 | 7.2 |
| Example 9 | 0.0614 | 0.0015 | 0.024 | 0.15 | 0.0760 | 84 | 7.0 |
| Comparative | 0.0640 | 0.0001 | 0.001 | 0.11 | 0.0780 | 82 | 10.4 |
| Example 1 | | | | | | | |
| Comparative | 0.0588 | 0.0062 | 0.095 | 0.20 | 0.0770 | 84 | 14.0 |
| Example 2 | | | | | | | |

TABLE 2

| | First stirring | Reduction | Second |
|---|---|---|---|
| | solid content | rate | stirring solid |
| | ratio | of stirring | content ratio |
| | (mass %) | torque (%) | (mass %) |
| Example 1 | 78.5 | 83 | 64 |
| Example 2 | 79.5 | 82 | 64 |
| Example 3 | 80.5 | 81 | 64 |
| Example 4 | 81.3 | 79 | 64 |
| Example 5 | 82.5 | 77 | 64 |
| Example 6 | 83.4 | 75 | 64 |
| Example 7 | 79.5 | 82 | 70 |
| Example 8 | 79.5 | 82 | 60 |
| Example 9 | 79.5 | 82 | 64 |
| Comparative | 85.0 | 68 | 64 |
| Example 1 | | | |
| Comparative | 75.0 | 89 | 64 |
| Example 2 | | | |

As is apparent from Tables 1 and 2, the amount of gas generation during charge/discharge cycles is smaller in the electrodes of Examples 1 to 9 than in the electrodes of Comparative Examples 1 and 2. Comparison of Examples 2, 7 and 8 which are identical in value of B/(A+B) shows that the amount of gas generation during charge/discharge cycles was smaller in the electrode of Example 2 in which the ratio of the pore volume (A+B) to the pore volume C is 80% or more and 90% or less than in the electrodes of Examples 7 and 8 in which the ratio was less than 80% or more than 90%.

Comparison between Examples 2 and 9 which are identical in composition of the lithium nickel cobalt manganese composite oxide and in pore volumes A, B and C shows that the amount of gas generation during charge/discharge cycles is smaller in the electrode of Example 2 with aggregates of monocrystalline particles of the lithium nickel cobalt manganese composite oxide than in the electrode of Example 9 with aggregates of polycrystalline particles of the lithium nickel cobalt manganese composite oxide.

The pore size diameter distributions of the electrodes (positive electrodes) of Examples 1 to 3 and Comparative Examples 1 and 2 are shown in FIG. 7. In the pore diameter distribution shown in FIG. 7, the horizontal axis represents a pore size diameter (μm), and the vertical axis represents a Log differential intrusion (mL/g). FIG. 7 also shows the pore size diameter distribution of the electrode (positive electrode) of a reference example. The positive electrode of the reference example is identical in composition to the positive electrode of Example 1. In the positive electrode of the reference example, the pore volume A was 0.0645 (mL/g), the pore volume B was 0.0145 (mL/g), B/(A+B) was 0.184, the ratio (%) of the pore volume (A+B) (mL/g) to the pore volume C (mL/g) was 89, and the pore size diameter at a peak top of a maximum peak was 0.25 (μm). The electrodes of Comparative Examples 1 and 2 and the reference example have a peak in a pore size diameter range of 0.1 μm or more and 0.3 μm as in Examples 1 to 6. Comparison of the pore size diameter distribution of the electrode of the reference example and the pore size diameter distribution of the electrode of Comparative Example 2 shows that the pore volume in the pore size diameter range of 0.3 μm to 1 μm is larger in the pore size diameter distribution of the electrode of the reference example than in Comparative Example 2, and the value of B/(A+B) of the electrode of the reference example is larger than B/(A+B) in Comparative Example 2.

### Example 10

As a positive electrode active material, aggregates of monocrystalline particles of a lithium nickel cobalt manganese composite oxide represented by a general formula LiₓNi_{1-a-b-c}COₐMn_{b}M_{c} (wherein x is 0.98, 1-a-b-c is 0.50, a is 0.20, b is 0.30 and c is 0.) were prepared. A positive electrode was produced in the same manner as in Example 2 except that this positive electrode active material was used.

A nonaqueous electrolyte secondary battery was produced in the same manner as in Example 1 except that the obtained positive electrode was used.

### Comparative Example 3

A positive electrode was produced in the same manner as in Comparative Example 1 except that aggregates of monocrystalline particles of a lithium-nickel-cobalt-manganese composite oxide having the same composition as in Example 10 were used as a positive electrode active material.

A nonaqueous electrolyte secondary battery was produced in the same manner as in Example 1 except that the obtained positive electrode was used.

For the secondary batteries of Example 10 and Comparative Example 3, the measurement of a 1C discharge capacity and a cycle test were performed to measure the amount of gas generation. The amount of gas generation in the secondary battery of Example 10 when the amount of gas generation in the secondary battery of Comparative Example 3 is assumed to be 100% is determined, and the results are shown in Table 3. The amount of gas generation in the secondary battery of Example 2 when the amount of gas generation in the secondary battery of Comparative Example 1 is assumed to be 100% is determined, and the results are shown in Table 3.

TABLE 3

| | Ni molar | | Amount of |
|---|---|---|---|
| | ratio | B/ | gas generation |
| | (1-a-b-c) | (A + B) | (%) |
| Example 2 | 0.80 | 0.024 | 60% |
| Comparative | 0.80 | 0.001 | 100% |
| Example 1 | | | |
| Example 10 | 0.50 | 0.024 | 95% |
| Comparative | 0.50 | 0.001 | 100% |
| Example 3 | | | |

From Table 3, the following can be seen. In the electrodes of Example 2 and Comparative Example 1, the molar ratio (1-a-b-c) of Ni in the oxide satisfies 0.6≤(1-a-b-c)≤0.9. Comparison of Example 2 and Comparative Example 1 shows that the amount of gas generation in the electrode of Example 2 in which B/(A+B) is larger than 0.001 and 0.09 or less is smaller by 40% than the amount of gas generation in the electrode of Comparative Example 1 in which B/(A+B) is outside the above range.

On the other hand, in the electrodes of Example 10 and Comparative Example 3, the molar ratio (1-a-b-c) of Ni in the oxide is 0.5. As is apparent from comparison of Example 10 and Comparative Example 3, the amount of gas generation in the electrode of Example 10 in which B/(A+B) is larger than 0.001 and 0.09 or less was smaller than that in the electrode of Comparative Example 3 in which B/(A+B) is outside the above range, but the reduction rate of the amount of gas generation was larger in Example 2.

In one or more embodiments and examples described above, an active material containing an oxide represented by a general formula LiₓNi_{1-a-b-c}COₐMn_{b}M_{c}O₂ (wherein x, a, b, and c satisfy 0.9≤x≤1.25, 0.05≤a≤0.5, 0.03≤b≤0.5, and 0≤c≤0.2; and M includes one or more metal elements other than Ni, Co and Mn) is contained. The electrode satisfies the expression (1). The electrode is capable of improving the capacity, and reducing the amount of gas generation during charge/discharge cycles. Thus, the charge/discharge cycle life can be improved.

$$0.001 < B / ( A + B ) \leq 0.09 \qquad ( 1 )$$

In the expression (1), A is a pore volume (mL/g) in a pore size diameter range of 0.01 μm or more and 0.3 μm or less in a mercury intrusion pore size diameter distribution of the electrode, and B is a pore volume (mL/g) in a pore size diameter range of more than 0.3 μm and 1 μm or less in a mercury intrusion pore size diameter distribution of the electrode.

In the following, the invention according to the embodiment is additionally written.

<1> An electrode including an active material including an oxide represented by a general formula LiₓNi_{1-a-b-c}CoₐMn_{b}M_{c}O₂ (wherein x, a, b and c satisfy 0.9≤x≤1.25, 0.05≤a≤0.5, 0.03≤b≤0.5, and 0≤c≤0.2, and M includes one or more metal elements other than Ni, Co and Mn), the electrode satisfying the following expression (1):

$$0.001 < B / ( A + B ) \leq 0.09 \qquad ( 1 )$$

wherein A is a pore volume (mL/g) in a pore size diameter range of 0.01 μm or more and 0.3 μm or less in a mercury intrusion pore size diameter distribution of the electrode, and B is a pore volume (mL/g) in a pore size diameter range of more than 0.3 μm and 1 μm or less in the mercury intrusion pore size diameter distribution.

<2> The electrode according to <1>, wherein the active material includes an aggregate of monocrystalline particles of the oxide.

<3> The electrode according to <1> or <2>, wherein a value of (1-a-b-c) in the general formula in the oxide is 0.6≤(1-a-b-c)≤0.9.

<4> The electrode according to any one of <1> to <3>, wherein a ratio of a pore volume (mL/g) represented by (A+B) in the expression (1) to a pore volume (mL/g) in a pore size diameter range of 0.01 μm or more and 60 μm or less is 80% or more.

<5> The electrode according to any one of <1> to <4>, which is a positive electrode for a lithium secondary battery.

<6>A secondary battery including a positive electrode, a negative electrode, and an electrolyte
the positive electrode being the electrode according to any one of <1> to <5>.

<7> The secondary battery according to <6>, wherein the negative electrode includes a lithium titanium-containing oxide.

<8> A battery pack including the secondary battery according to <6> or <7>.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electrode comprising an active material comprising an oxide represented by a general formula LiₓNi_{1-a-b-c}CoₐMn_{b}M_{c}O₂ (wherein x, a, b and c satisfy 0.9≤x≤1.25, 0.05≤a≤0.5, 0.03≤b≤0.5, and 0≤c≤0.2, and M includes one or more metal elements other than Ni, Co and Mn), the electrode satisfying the following expression (1):
$$0.001 < B / ( A + B ) \leq 0.09 \qquad ( 1 )$$
wherein A is a pore volume (mL/g) in a pore size diameter range of 0.01 μm or more and 0.3 μm or less in a mercury intrusion pore size diameter distribution of the electrode, and B is a pore volume (mL/g) in a pore size diameter range of more than 0.3 μm and 1 μm or less in the mercury intrusion pore size diameter distribution.

2. The electrode according to claim 1, wherein the active material comprises an aggregate of monocrystalline particles of the oxide.

3. The electrode according to claim 1, wherein a value of (1-a-b-c) in the general formula in the oxide is 0.6≤(1-a-b-c)≤0.9.

4. The electrode according to claim 1, wherein a ratio of a pore volume (mL/g) represented by (A+B) in the expression (1) to a pore volume (mL/g) in a pore size diameter range of 0.01 μm or more and 60 μm or less is 80% or more.

5. The electrode according to claim 1, which is a positive electrode for a lithium secondary battery.

6. A secondary battery comprising a positive electrode, a negative electrode, and an electrolyte
the positive electrode being the electrode according to claim 1.

7. The secondary battery according to claim 6, wherein the negative electrode comprises a lithium titanium-containing oxide.

8. A battery pack comprising the secondary battery according to claim 6.
